(19) United States
(12) Patent Application Publication
(10) Pub. No.: US 2009/0124508 A1
(43) Pub. Date: May 14, 2009

(54) Computational diagnostic methods for identifying organisms and applications thereof

(76) Inventor: Anthony Peter Caruso, Harvard, MA (US)

Correspondence Address: STERNE, KESSLER, GOLDSTEIN & FOX P.L.L.C., 1100 NEW YORK AVENUE, N.W., WASHINGTON, DC, 20005, US

(21) Appl. No.: 12/149,534

(22) Filed: May 2, 2008

Related U.S. Application Data
(60) Provisional application No. 60/915,584, filed on May 2, 2007.

(51) Int. Cl. C40B 30/02

(52) U.S. Cl. 506/8

(57) ABSTRACT

Methods for identifying organisms within a mixture using a minimal set of reagents are provided. The methods also allow for identifying the presence of not yet sequenced organisms, as well as for classification based on evolutionary lineage.

### CROSS-REFERENCE TO RELATED APPLICATIONS

The present application claims the benefit of U.S. Provisional Patent Application No. 60/915,584, filed May 2, 2007, the disclosure of which is incorporated herein in its entirety.

### BRIEF SUMMARY OF THE INVENTION

Methods for identifying organisms within a mixture using a minimal set of reagents are provided. The methods also allow for identifying the presence of not yet sequenced organisms, as well as for classification based on evolutionary lineage.

Methods for generating a decision path for determining the presence of an organism in a sample are provided. Suitably, two or more organism information sequences are provided, and then aligned. One or more common regions of the organism information sequences are then determined. The number of probes required to identify the one or more organism information sequences are then determined, thereby determining one or more decision paths for determining the presence of an organism. Suitably, the organism information sequences are nucleic acid and/or amino acid sequences. The organism information sequences can comprise eukaryotic or prokaryotic sequences, or a mixture thereof.

Methods are also provided for identifying an organism. Suitably, a plurality of organisms is provided. One or more organism information sequences of the organisms are then provided, and a first set of probes are applied organism information sequences. The presence of a target organism information sequence is then determined, wherein an interaction between one or more probes of the first set and a first target organism information sequence indicates the presence of the first organism information sequence. A decision path is then applied to determine a subsequent set of probes to be applied. This subsequent set of probes is then applied to the organism information sequences, wherein an interaction between one or more probes of the subsequent set and a second target organism information sequence indicates the presence of the second target organism information sequence. The applying and determining are then repeated one or more times, wherein a final interaction between one or more probes and a final target organism information sequence identifies the organism.

Decision paths for determining the presence of an organism in a sample are also provided. Suitably, the decision paths are generated by a method comprising providing two or more organism information sequences. The organism information sequences are then aligned, and one or more common regions of the organism information sequences are determined. The number of probes required to identify the one or more organism information sequences are then determined, thereby generating one or more decision paths for determining the presence of an organism.

### BRIEF DESCRIPTION OF THE DRAWINGS/FIGURES

FIG. 1 shows an exemplary flowchart for generating a decision path for determining the presence of an organism.

FIGS. 2A-2B show an exemplary method for computationally identifying similar sequences in one or more organisms.

FIGS. 3A-3B show an exemplary method for applying a decision path.

FIG. 3C shows an exemplary alignment of organism information sequences.

FIG. 4 shows another exemplary method for applying a decision path.

### DETAILED DESCRIPTION OF THE INVENTION

Methods for generating a decision path for determining the presence of an organism in a sample are provided. Suitably, tow or more organism information sequences are provided, and the organism information sequences are then aligned. Common regions of the organism information sequences are determined, and a number of probes required to identify the organism information sequences are determined, thereby determining one or more decision paths for determining the presence of an organism.

As used herein, the term “probe” includes nucleic acid and protein-based (amino acid) probes or primers. The terms “probe” and “primer” are used interchangeably throughout. “Organism information sequences” include nucleic acid and amino acid sequences representing the genomic and proteomic sequences of an organism. As used herein, “decision path” and “pre-calculated decision path” are used interchangeably to mean algorithms or decision trees or paths that can be used to determine the presence of an organism.

The probes and primers for use in the disclosed methods are designed based on known gene/genomic or proteomic sequences. The probes and primers are suitably one of two types, 1) unique/specific for any given organism based on currently available sequence data, or 2) common across (i.e., conserved regions) more than one organism. A single common probe may be representative of thousands of organisms in some cases, which gives the algorithm/decision path great breadth in narrowing what may be present in a sample. Such probes are considered to have a more general specificity. Conversely, a common probe may be designed from a cluster of only two organisms, and thus will provide greater specificity as to which particular species is present in a sample. Such probes are considered to have a more detailed specificity since they represent fewer organisms. All probes will be hierarchical in nature from the most general to those with greater specificity. Considering this hierarchy, a decision path is calculated from each common probe to all of the organisms it represents, as in a parent-child relationship. As a consequence, the reverse path will also be available, meaning that from any given organism the expected probes, common and unique, can be determined.

Depending on how many probes can be practically made available per assay, and which organism are to be detected, a target sample can first be assayed using a panel of probes with a general specificity being able to capture the presence or absence of the organism(s) of interest. The assay can then be conducted in rounds, whereby the results from an earlier round will dictate, based upon the pre-determined decision path, which probes to use in a subsequent round, and so on. The final round will normally contain unique probes as part of the assay to identify specific organisms.

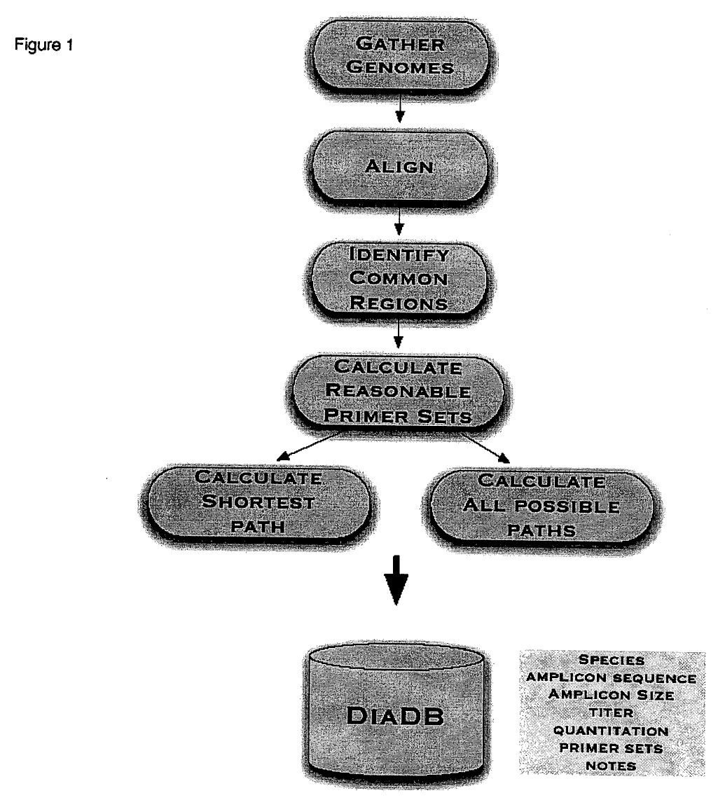

FIG. 1 outlines the general workflow for pre-computing the information for probe/primer design. The results of these computations are stored within a DiaDB (Diagnostics Database) (e.g., a computer database). As used herein the phrase “gather genomes” includes providing one or more organism information sequences, including nucleic acid and/or protein sequences of an organism. Probes can comprise any nucleic acid or protein/amino acid sequences, and can be of any length, e.g., on the order of 10's, to hundreds, to thousands of base-pairs or amino acids in length. Probes are designed to bind to specific regions (target regions or target organism information sequences) of the genomic or proteomic sequence via homologous nucleotide base-pairing or protein-protein interactions (including antibody-protein sequence interactions). Probes can suitably be labeled using well known techniques in the art, such as fluorescent labeling, radioactive labeling, colorimetric labeling, etc. Nucleic acid probes can utilize wobble bases if desired, including inosine which can pair with uracil, adenine, or cytosine and the G-U base pair, which allows uracil to pair with guanine or adenine, thus allowing for the use of degenerate bases.

Preparation of nucleic acid and protein sequence probes can be accomplished using well-known methods in the art. See e.g., chapters 2, 4, 6 and 10 in Current Protocols in Molecular Biology, Ausubel et al. Eds., John Wiley and Sons, New York, 1997, the disclosure of which is incorporated by reference herein in its entirety.

In exemplary embodiments, probes are prepared that are directed to highly conserved regions of organisms, including functional domains and motifs, and ribosomal RNA. However, as regions can be too well conserved between organisms, it may be necessary to select other regions. Multiple probes can also be used so as to differentiate between similar regions of organisms. In embodiments where identified regions of known/unknown organisms in a given sample are closely related, or for very short probes (e.g., about 10-30 nucleotides in length), melting curves can be used to identify more specific interactions so as to ensure the presence of a probe-information sequence (motif) interaction. Thus, probe-motif interactions that are less specific will degenerate at a lower temperature than more specific probe-motif interactions.

The disclosed methods allow for fast assay of organism sequence data, and the ability to quickly adapt to newly identified species. The methods can easily be adapted to various assay platforms including microarrays, polymerase chain reaction (PCR), including real-time PCR, quantitative PCR, etc., as well as northern and southern blots. See U.S. Pat. Nos. 4,683,202, 6,814,934, and 6,171,785 and Ausubel et al. supra for descriptions of these techniques, the disclosures of each of which are incorporated by reference herein in their entireties.

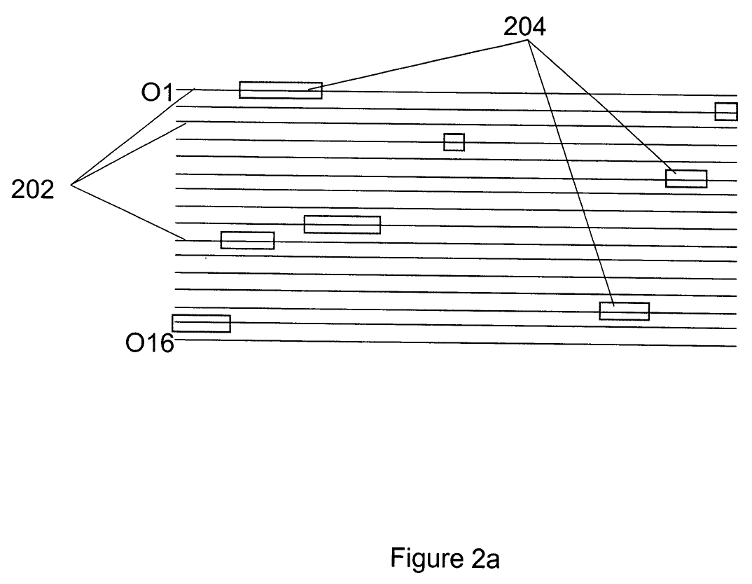

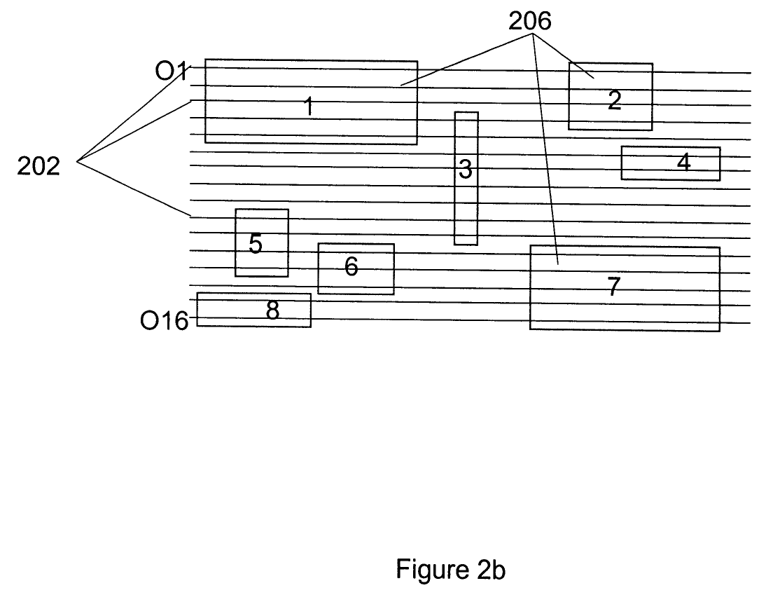

FIG. 2A illustrates the identification of unique motifs 204 within the information sequences of known organisms. FIG. 2A shows a schematic of information sequences 202 from sixteen (16) organisms, O1-O16. Exemplary organisms include eukaryotes (including plants, animals (including humans), fungi, etc.) and prokaryotes (including various bacteria). The identified regions can be used to design specific probes that allow for the detection of a specific organism from a sample. For example, a particular species of bacteria can be identified by a unique sequence region, and therefore a probe can be designed that will allow for the specific identification of that species. Identification of a specific organism using these methods relies on the use of heuristic algorithms. However, identification of unknown organisms requires the identification of conserved sequence regions as discussed in detail throughout. It should be noted that organism information sequences can be aligned from the same or different organisms.

FIG. 2B illustrates computationally identifying the most highly conserved regions between sequences by way of a sequence alignment within and across the information sequences (genomes (nucleic acids) and proteomes (protein sequences)) of existing known (e.g., sequence information is known in the art) sequences of organisms. FIG. 2B shows a schematic of the alignment of information sequences 202 from sixteen (16) organisms, O1-O16. Exemplary organisms include eukaryotes (including plants, animals (including humans), fungi, etc.), prokaryotes (including various bacteria) and viruses. These methods can be used to identify areas that are highly specific from organism to organism. For example, regions that are specific to a certain genus of organism can be identified, or regions that are specific to a certain species of organism can be identified. This identification allows for the generation of a database of regions that can be used to identify organisms at the genus and/or species level (as well as other classification levels).

Probe and/or primer sets can be designed to bind within these regions 206, and a minimal set of cascading experiments can be determined to detect the presence of organisms in a given sample or mixture. These pre-calculated decision paths are stored within the DiaDB database. FIG. 2B illustrates the identification of eight (8) highly conserved regions 206 across a number of organisms, shown as boxes for clarity. The methods also allow for the use of degenerate nucleotide bases in the probes where the identification of a single consensus reside at a given position is not possible.

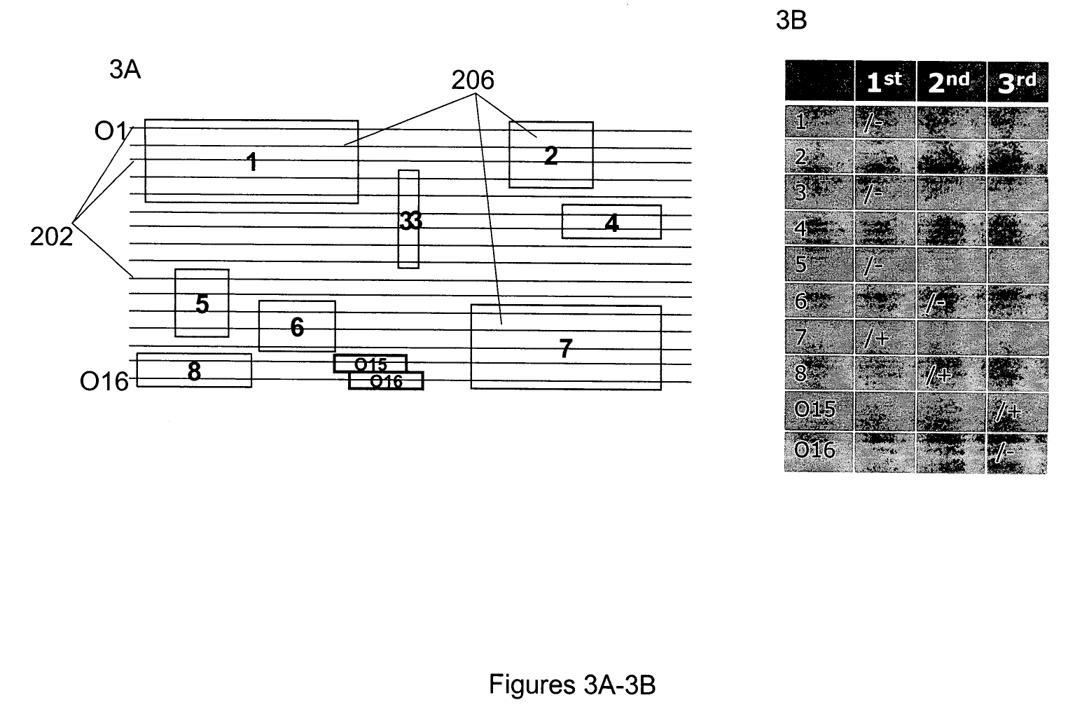

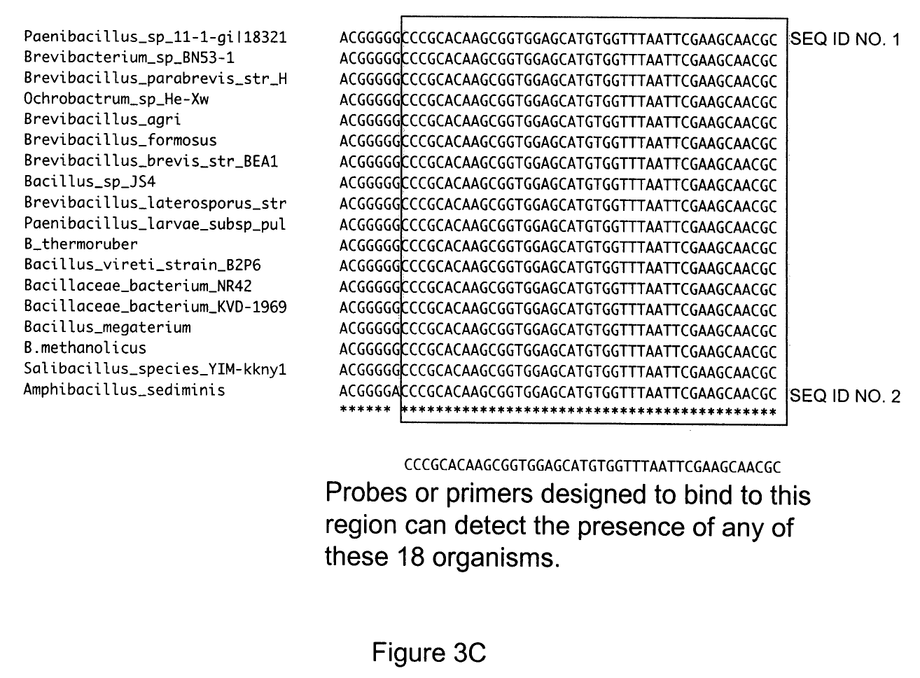

FIGS. 3A-3B illustrate an exemplary workflow based on primers/probes designed using methods such as those exemplified in FIGS. 2A and 2B. When using low throughput technologies, such as quantitative PCR (qPCR), calculations stored within the DiaDB will yield a reasonable amount of primers/probes to experiment within an initial round. Using the pre-computed decision path information stored in the DiaDB, the results from this experiment will then dictate which primer/probe sets to use in a second round, and so on. This iteration continues until the species/organism has been identified. Using this method with higher throughput techniques such as micro-arrays will allow for the use more primers or probes to be included in each round of the decision path as more interactions can be quickly determined.

The number of iterations of probe-sequence interactions conducted is inversely proportional to the complexity of the domains identified. That is, if very complex domains can be identified for a given organism, the presence of such an organism can be identified using fewer iterations of the disclosed methods as compared to organisms where a less complex domain has been identified. Once the paths have been determined to identify all sequenced organisms, including for example the shortest path, and knowing which technology will be utilized for the amplification and identification (for example how many primers/probes will be used in any given round), it is possible to calculate the minimum and maximum number of rounds to be carried out to identify any species within a mixture.

For example, as shown in FIGS. 3A and 3B, initial rounds of testing can include probing a sample of information sequences (i.e., protein or nucleic acid sequences) with probes designed to target conserved regions 1-8, as represented by boxes in FIG. 3A. Examples of conserved regions 1-8 include functional domains or motifs of organisms that distinguish one organism from another. A detailed discussion of the use of alignment to determine conserved sequences can be found in, for example, Kumar and Filipski, “Multiple sequence alignment: In pursuit of homologous DNA positions, Genome Res. 17:127-135 (2007), the disclosure of which is incorporated by reference herein in its entirety.

As shown in FIG. 3C, alignment of sequences from eighteen bacteria identify conserved region(s) of the genomes. Thus, one or more nucleic acid probes or primers can be designed so as to recognize these conserved regions, thus allowing for the identification of an unknown (or known) organism as a member of this group of organisms, or even as similar to these organisms.

As represented in FIG. 3B, a first round can include applying/probing the sample with probes for regions 1, 3, 5 and 7. As used herein “applying” includes any method of contacting the probes and the organism information sequences. Appropriate conditions under which to apply the probes to the organism information sequences, including temperature, pH, buffer concentrations and components, are well known in the art. See Ausubel et al. Obtaining a positive response (i.e., an interaction) with the probe for region 7 (i.e., a first target organism information sequence) would then determine the next set of probes to select for use in the next round (by applying the decision path), for example, probes for regions 6 and 8, so as to further identify the organism. As represented in the second round of testing in FIG. 3B, a positive response with only a probe for region 8 (i.e., a second target organism information sequence) would then lead to the selection of probes for regions 15 and 16 in the third round of testing. Finally, in this example, in round 3, a probe interaction with only region 15 (i.e., a final target organism information sequence) identifies the organism. It should be noted that any number of rounds of testing can be utilized, or may be required, to ultimately identify an organism. This identification can be on the level of class, order, family, genus, species, strain and/or specific organism. Hence, these methods will also be useful in the identification of organisms with genomes that have not yet been sequenced (e.g., unknown organisms). Since only a very small proportion of the genomes or proteomes all existing organisms have been sequenced, it is expected that organisms with unknown genome or proteome sequences will be within a given mixture being sampled. In these cases the design of the primers/probes within conserved regions will assist in categorizing these previously unknown or uncharacterized organisms. As an example, in FIG. 3A, conserved region 6 may be specific to Gram positive thermophiles. If after running several rounds of testing region 6 is positive (e.g., identified as interacting with the probes), but no further rounds trying to hone in on a known genome are positive, it would indicate an unknown Gram positive thermophile was present within the mixture.

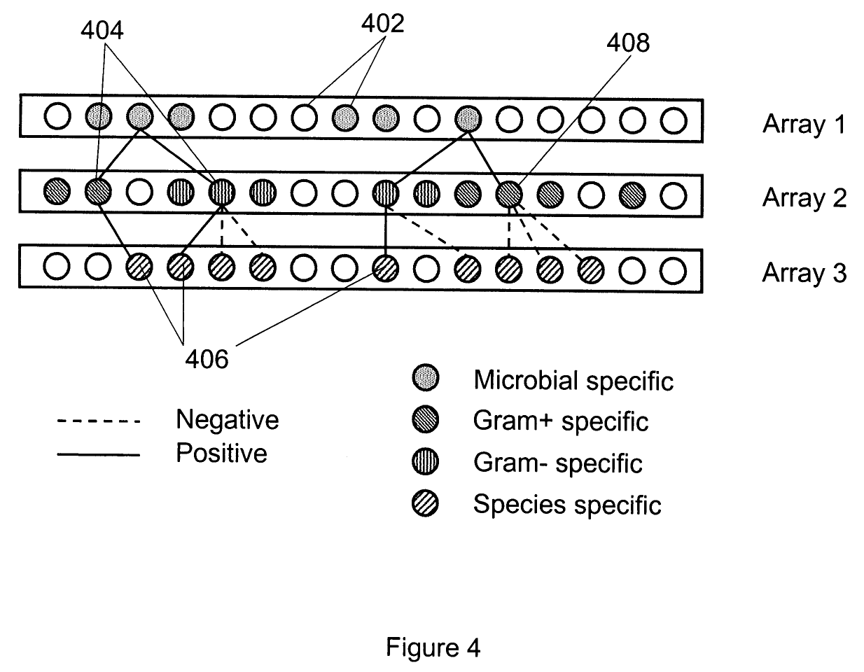

An additional exemplary embodiment is represented in FIG. 4. The arrays shown in FIG. 4 comprise samples 402 which suitably will contain either single organisms or multiple organisms. Initially, a first round of probes is applied to array 1 to identify information sequences which contain motifs that have been identified as being unique to microbial organisms. A second set of primers is selected so as to identify between gram positive (Gram+) and gram negative (Gram−) organisms, and a second round of testing is performed. As represented in FIG. 4, a positive interaction 404 (represented by a solid line) indicates that the samples contain both Gram+ and Gram− organisms. A third set of primers is selected and a further test is performed to determine whether specific species are present in the samples. Again, solid lines indicate a positive interaction. As shown in the exemplary embodiment of FIG. 4, three unique species 406 can be identified in the samples. However, no unique species are identified in some samples, e.g., 408. Thus, while it could be concluded that this sample contains a Gram+bacteria, no further identification of the organism would be able to be made with this set of probes. Certainly, the discovery of new organisms could then be used to add to the probe database.

It is also possible with the use of standards and a set of pre-calculated expectancies to establish a reasonable ability to titer the population of each identified region in the sample. This quantification step would be useful when this method is used within an uncontrolled environment where many background species will be present in small quantities. For example, if used in the agricultural industry or by the FDA as a diagnostic for the presence of pathogenic bacterial strains that may be contaminating a food crop, it is expected that this method could be used to detect the deadly pathogen Bacillus anthracis (the caustic agent of Anthrax), which is normally found in small, non-toxic quantities within the soil. In one embodiment, these background data, experimentally determined and pre-computed, are stored within the DiaDB database. Additional uses of the disclosed methods include medical uses, (such as diagnostic uses), waste treatment uses, manufacturing uses, etc.

The disclosed methods allow for the calculation of all of the possible paths (i.e., required iterations and probes) for the detection of an unknown species, as well as the minimum number of iterations to determine the presence of a specific class, order, family, genus, species, strain and/or specific organism. Signatures can also be established for all known classes, orders, families, genera, species and organisms. The disclosed methods allow for the prediction of patterns to expect and those not to expect.

Exemplary embodiments have been presented. The methods and applications described herein are not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

What is claimed is:

1. A method for generating a decision path for determining the presence of an organism in a sample, comprising:
(a) providing two or more organism information sequences;
(b) aligning the two or more organism information sequences;
(c) determining one or more common regions of the organism information sequences; and
(d) determining a number of probes required to identify the one or more organism information sequences, thereby determining one or more decision paths for determining the presence of an organism.

2. The method of claim 1, wherein (a) comprises providing nucleic acid and/or amino acid organism information sequences.

3. The method of claim 2, wherein (a) comprises providing eukaryotic or prokaryotic sequences, or a mixture thereof.

4. A method for identifying an organism, comprising:
(a) providing a plurality of organisms;
(b) providing one or more organism information sequences of the organisms;
(c) applying a first set of probes to the organism information sequences;
(d) determining the presence of a target organism information sequence, wherein an interaction between one or more probes of the first set and a first target organism information sequence indicates the presence of the first organism information sequence;
(e) applying a decision path to determine a subsequent set of probes to be applied;
(f) applying the subsequent set of probes to the organism information sequences, wherein an interaction between one or more probes of the subsequent set and a second target organism information sequence indicates the presence of the second target organism information sequence; and
(g) repeating (e)-(f) one or more times, wherein a final interaction between one or more probes and a final target organism information sequence identifies the organism.

5. The method of claim 4, wherein (b) comprises providing nucleic acid and/or amino acid organism information sequences.

6. The method of claim 5, wherein (b) comprises providing eukaryotic or prokaryotic sequences, or a mixture thereof.

7. A decision path for determining the presence of an organism in a sample, the decision path generated by a method comprising:
(a) providing two or more organism information sequences;
(b) aligning the two or more organism information sequences;
(c) determining one or more common regions of the organism information sequences; and
(d) determining a number of probes required to identify the one or more organism information sequences, thereby generating one or more decision paths for determining the presence of an organism.

8. The decision path of claim 7, wherein (a) comprises providing nucleic acid and/or amino acid organism information sequences.

9. The decision path of claim 8, wherein (a) comprises providing eukaryotic or prokaryotic sequences, or a mixture thereof.


SEQUENCE LISTING (2 sequences)

SEQ ID NO: 1 - DNA, 50 bp, Paenibacillus sp.
acgggggcccgcacaagcggtggagcatgtggtttaattcgaagcaacgc

SEQ ID NO: 2 - DNA, 50 bp, Amphibacillus sediminis
acggggacccgcacaagcggtggagcatgtggtttaattcgaagcaacgc